(19) United States
(12) Patent Application Publication
(10) Pub. No.: US 2026/0205721 A1
(43) Pub. Date: Jul. 16, 2026

(54) IMAGING DEVICE

(71) Applicant: CANON KABUSHIKI KAISHA, Tokyo (JP)

(72) Inventor: MASASHI NIWA, Chiba (JP)

(21) Appl. No.: 19/436,697

(22) Filed: Dec. 30, 2025

(30) Foreign Application Priority Data
Jan. 10, 2025 (JP) 2025-003980

(51) Int. Cl. H04N 25/78; H04N 25/46; H04N 25/771; H04N 25/773

(52) U.S. Cl. CPC H04N 25/78; H04N 25/46; H04N 25/771; H04N 25/773

(57) ABSTRACT

An imaging device includes a pixel including a light receiving unit configured to receive light and generate a pulse signal, and a counter configured to count the pulse signal, a readout unit configured to read a count value of the pulse signal in each of N subframe periods, where N is an integer of 2 or more and a frame period includes the N subframe periods, an integration unit configured to integrate the count values read by the readout unit, and an output unit configured to output a first integrated value obtained by integrating the count values of the N subframe periods by the integration unit, wherein the output unit determines, for each of N subframes, whether to output a second integrated value obtained by integrating the count values of M subframe periods using the integration unit, where M is smaller than N.

### BACKGROUND

### Field of the Technology

The present disclosure relates to an imaging device.

### Description of the Related Art

Conventionally, there is an imaging device including a pixel having an avalanche photodiode (APD) capable of detecting weak light at a single photon level. The imaging device disclosed in Japanese Patent Laid-Open No. 2023-076345 includes a pixel including a counter for counting a signal from an APD in a frame period, and an external memory provided outside the pixel. The imaging device disclosed in Japanese Patent Laid-Open No. 2023-076345 stores a value obtained by integrating count values from the counter in an external memory, thereby increasing the number of bits of the integrated value while suppressing the number of bits of the counter.

However, in Japanese Patent Laid-Open No. 2023-076345, a plurality of integrated values cannot be output from the count value of the frame period.

### SUMMARY

The present disclosure is directed to provide an imaging device capable of outputting a plurality of integrated values from a count value of a frame period.

According to one aspect of the present specification, there is provided an imaging device including a pixel including a light receiving unit configured to receive light and generate a pulse signal, and a counter configured to count the pulse signal, a readout unit configured to read a count value of the pulse signal in each of N subframe periods, where N is an integer of 2 or more and a frame period includes the N subframe periods, an integration unit configured to integrate the count values read by the readout unit, and an output unit configured to output a first integrated value obtained by integrating the count values of the N subframe periods by the integration unit, wherein the output unit determines, for each of N subframes, whether to output a second integrated value obtained by integrating the count values of M subframe periods using the integration unit, where M is smaller than N.

Features of the present disclosure will become apparent from the following description of embodiments with reference to the attached drawings. The following description of embodiments is described by way of example.

### BRIEF DESCRIPTION OF THE DRAWINGS

FIG. 1 is an exploded perspective view of an imaging device according to a first embodiment.

FIG. 2 is a block diagram of a circuit substrate according to the first embodiment.

FIG. 3A is a diagram illustrating a configuration of a pixel according to the first embodiment.

FIG. 3B is a diagram illustrating an operation of the pixel according to the first embodiment.

FIG. 4 is a schematic diagram of operation timing of the imaging device according to the first embodiment.

FIG. 5 is a diagram illustrating an operation of a readout unit according to the first embodiment.

FIG. 6 is a timing chart of the imaging device according to the first embodiment.

FIG. 7 is a block diagram of a circuit substrate according to a second embodiment.

FIG. 8 is a schematic diagram of operation timing of an imaging device according to the second embodiment.

FIG. 9 is a block diagram of a circuit substrate according to a third embodiment.

FIG. 10 is a timing chart of an imaging device according to the third embodiment.

FIG. 11 is a circuit diagram of a memory and a signal line according to a fourth embodiment.

FIG. 12A and FIG. 12B are diagrams illustrating an operation of a readout unit according to the fourth embodiment.

FIG. 13 is a schematic diagram of operation timing of an imaging device according to the fourth embodiment.

FIG. 14 is a block diagram of a device according to a fifth embodiment.

FIG. 15A and FIG. 15B are block diagrams of an equipment according to a sixth embodiment.

### DESCRIPTION OF THE EMBODIMENTS

### First Embodiment

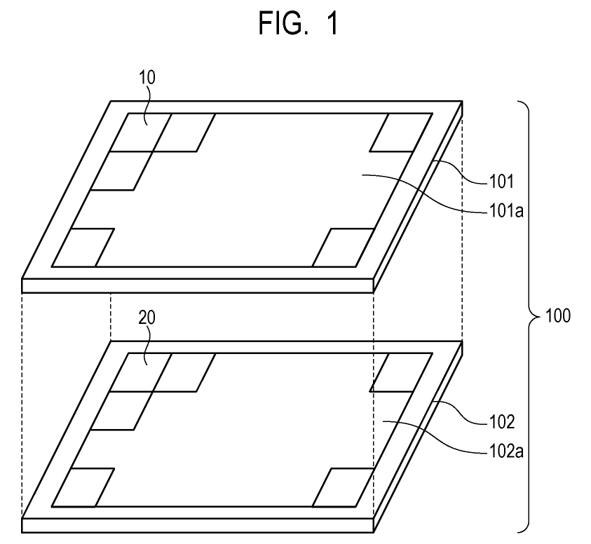

FIG. 1 is an exploded perspective view of an imaging device 100 according to a first embodiment. The imaging device 100 includes a sensor substrate 101 and a circuit substrate 102. The sensor substrate 101 and the circuit substrate 102 are stacked and electrically connected to each other. The imaging device 100 includes a plurality of pixels. The plurality of pixels typically form an image signal, but do not necessarily form an image signal when used for time-of-flight (TOF) imaging. The pixel includes an avalanche photodiode (APD) 10 and a signal processing circuit 20.

A plurality of APDs 10 are provided in two-dimensional array in a pixel region 101a of the sensor substrate 101. The APD 10 is a photoelectric conversion element that converts light into an electrical signal.

A plurality of signal processing circuits 20 are provided in a circuit region 102a of the circuit substrate 102. Each of the plurality of signal processing circuits 20 is electrically connected to each APD 10 via an interconnection. The signal processing circuit 20 converts an electrical signal from the APD 10 into a pulse signal and counts the pulse signal.

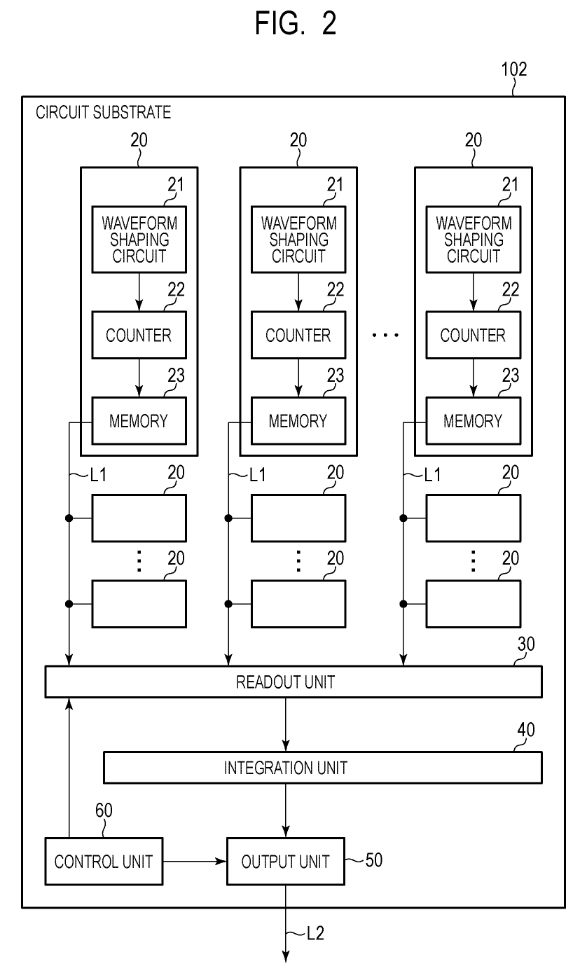

FIG. 2 is a block diagram of the circuit substrate 102 according to the present embodiment. The circuit substrate 102 includes the plurality of signal processing circuits 20, a vertical scanning circuit, a readout unit 30, an integration unit 40, an output unit 50, and a control unit 60.

The signal processing circuit 20 includes a waveform shaping circuit 21, a counter 22, and a memory 23. The waveform shaping circuit 21 converts an electrical signal from the APD 10 into a pulse signal and outputs the pulse signal to the counter 22.

The counter 22 counts the pulse signal from the waveform shaping circuit 21, and outputs a count value of a plurality of bits to the memory 23. The counter 22 may be configured by four bits, but is not limited to four bits, and may be a plurality of bits. The counter 22 receives a reset signal from the vertical scanning circuit and resets all bits.

The memory 23 holds the count value from the counter 22. The memory 23 may be configured by a 4-bit latch circuit, but is not limited thereto, and may be other storage elements. The memory 23 is connected to the readout unit 30 via a signal line L1, and outputs the count value to the readout unit 30.

The vertical scanning circuit receives a control signal from the control unit 60 and outputs a driving control signal to the pixels. A logic circuit such as a shift register or an address decoder may be used as the vertical scanning circuit. The vertical scanning circuit sequentially scans the pixels in the circuit region 102a row by row and sequentially causes each pixel to output the count value to the readout unit 30.

The readout unit 30 receives a control signal from the control unit 60, reads out a count value from the memory 23 of the pixel in units of rows, and outputs the count value to the integration unit 40. A logic circuit such as a shift register or an address decoder may be used as the readout unit 30.

The integration unit 40 integrates the count value from the readout unit 30 for each pixel. The integration unit 40 includes an integration memory that holds the integrated value of the count values. The integration unit 40 integrates the count value from the readout unit 30 with the count value read out from the integration memory for each pixel and writes the integrated value into the integration memory. The integration unit 40 outputs the integrated value to the output unit 50.

The output unit 50 receives a control signal from the control unit 60, and outputs the integrated value from the integration unit 40 as a pixel value to the outside of the imaging device 100 via a signal line L2.

The control unit 60 generates control signals for controlling the operations and timings of the vertical scanning circuit, the readout unit 30, and the output unit 50, and outputs the control signals to the functional blocks. At least a part of the control signal may be output from the outside of the imaging device 100. The control unit 60 may include various electronic components such as a CPU and a memory.

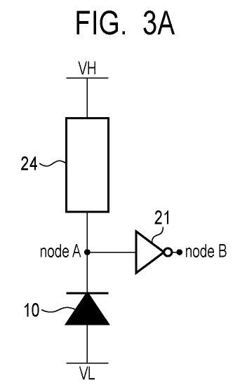

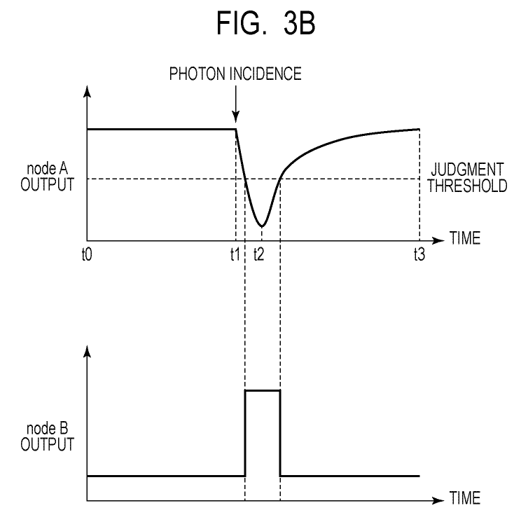

FIGS. 3A and 3B are diagrams illustrating a configuration and an operation of the pixel according to the present embodiment. FIG. 3A is a diagram in which the APD 10, a quenching element 24, and the waveform shaping circuit 21 are extracted in the pixel. The APD 10, the quenching element 24, and the waveform shaping circuit 21 are an example of a light receiving unit. The input side of the waveform shaping circuit 21 is a node A, and the output side thereof is a node B. FIG. 3B illustrates waveform changes of the nodes A and B of FIG. 3A.

A voltage VL is applied to an anode of the APD 10, and a voltage VH higher than the voltage VL is applied to a cathode of the APD 10. A reverse bias voltage that induces an avalanche multiplication operation by the APD 10 is applied to the anode and the cathode. When a photon enters the APD 10, a charge generated by the incidence of the photon causes avalanche multiplication, and an avalanche current is generated. The operation modes of the APD 10 include a Geiger mode and a linear mode. In the Geiger mode, the reverse bias voltage applied between the anode and the cathode is set to be higher than the breakdown voltage of the APD 10. In the linear mode, the reverse bias voltage applied between the anode and the cathode is close to or lower than the breakdown voltage of the APD 10. When operating in Geiger mode, the APD 10 is referred to as a SPAD (Single Photon Avalanche Diode). The APD 10 may operate in the linear mode or the Geiger mode.

The quenching element 24 is connected to a power supply for applying the voltage VH and the cathode of the APD 10. The quenching element 24 converts a change in the avalanche current generated in the APD 10 into a voltage signal (electrical signal). The quenching element 24 functions as a load circuit (quench circuit) at the time of signal multiplication by avalanche multiplication, and suppresses the voltage applied to the APD 10 to suppress avalanche multiplication.

The waveform shaping circuit 21 includes an input node to which an electric signal from the APD 10 is input and an output node connected to the counter 22. The waveform shaping circuit 21 may include, for example, one inverter circuit. The waveform shaping circuit 21 may be configured by a circuit in which a plurality of inverter circuits are connected in series. Further, the waveform shaping circuit 21 may be configured not only by a NOT circuit but also by other circuits having a waveform shaping effect, such as a logic circuit including a NOR circuit, a NAND circuit, and the like.

Between time t0 and time t1, a voltage (VH - VL) is applied to the APD 10 in FIG. 3A. When a photon is incident at time t1, an avalanche multiplication current flows through the quenching element 24, and the voltage of the node A drops. When the voltage drop amount further increases and the potential difference applied to the APD 10 decreases, the avalanche multiplication of the APD 10 stops, and the voltage level of the node A no longer drops below a certain value (time t2). After that, a current that compensates for the voltage drop flows from the voltage VL side to the node A, and the node A is settled to the original potential level at time t3. At this time, a portion where the output waveform exceeds a judgment threshold in the node A is shaped by the waveform shaping circuit 21, and is output as a pulse signal in the node B.

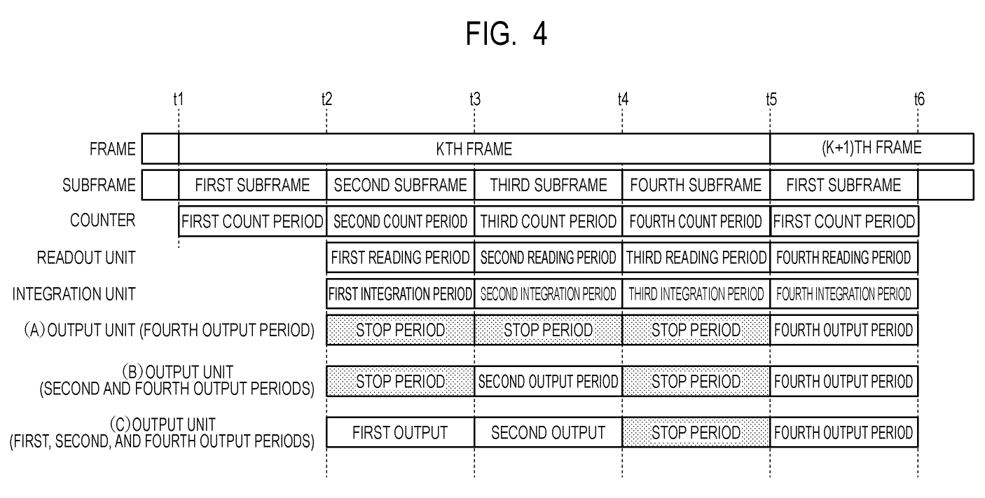

FIG. 4 is a schematic diagram of operation timing of the imaging device 100 according to the present embodiment. A frame period in which a frame is generated includes N subframe periods. Each of the N subframe periods has the same length and a subframe is generated in the subframe period. N is an integer of 2 or more, and is, for example, "4". The frame includes first to fourth subframes.

In the first count period from time t1 to time t2, the counter 22 counts the pulse signal for generating the first subframe. The first count period corresponds to a first subframe period. The memory 23 holds the count value from the counter 22. After the first count period ends, the counter 22 receives a reset signal from the vertical scanning circuit and resets all bits.

In the first readout period from time t2 to time t3, the readout unit 30 reads out the count value of the first subframe from the memory 23 of the plurality of pixels in units of rows and outputs the count value to the integration unit 40. Note that the first readout period has a length corresponding to the subframe period. The second to fourth readout periods described later also have a length corresponding to the subframe period.

In the first integration period from time t2 to time t3, the integration unit 40 stores the count value of the first readout period in the integration memory.

In the second count period from time t2 to time t3, the counter 22 counts the pulse signal for generating the second subframe. The second count period corresponds to a second subframe period. The memory 23 holds the count value from the counter 22. After the second count period ends, the counter 22 resets all bits.

In the second readout period from time t3 to time t4, the readout unit 30 reads out the count value of the second subframe from the memory 23 of the plurality of pixels in units of rows and outputs the count value to the integration unit 40.

In the second integration period from time t3 to time t4, the integration unit 40 integrates the count value of the second readout period with the count value of the integration memory for each pixel and stores the integrated value in the integration memory. The integrated value (second integrated value) is a value obtained by integrating the count values of the first and second subframes.

In the third count period from time t3 to time t4, the counter 22 counts the pulse signal for generating the third subframe. The third count period corresponds to a third subframe period. The memory 23 holds the count value from the counter 22. After the third count period ends, the counter 22 resets all bits.

In the third readout period from time t4 to time t5, the readout unit 30 reads out the count value of the third subframe from the memory 23 of the plurality of pixels in units of rows and outputs the count value to the integration unit 40.

In the third integration period from time t4 to time t5, the integration unit 40 integrates the count value of the third readout period with the count value of the integration memory for each pixel and stores the integrated value in the integration memory. The integrated value is a value obtained by integrating the count values of the first to third subframes.

In the fourth count period from time t4 to time t5, the counter 22 counts the pulse signal for generating the fourth subframe. The fourth count period corresponds to a fourth subframe period. The memory 23 holds the count value from the counter 22. After the fourth count period ends, the counter 22 resets all bits.

In the fourth readout period from time t5 to time t6, the readout unit 30 reads out the count value of the fourth subframe from the memory 23 of the plurality of pixels in units of rows and outputs the count value to the integration unit 40. In this way, the readout unit 30 reads out the count values in chronological order of the first to fourth subframe periods.

In the fourth integration period from time t5 to time t6, the integration unit 40 integrates the count value of the fourth readout period with the count value of the integration memory for each pixel and stores the integrated value in the integration memory. The integrated value (first integrated value) is a value obtained by integrating the count values of the first to fourth subframes. That is, the integrated value in the fourth integration period is the pixel value of one frame. The integration unit 40 sequentially integrates the count values in the order in which the readout unit 30 reads out the count values.

In the fourth output period from time t5 to time t6, as illustrated in (A) of FIG. 4, the output unit 50 outputs the integrated value of each pixel in the fourth integration period as a pixel value to the outside of the imaging device 100. In the first to third output periods from time t2 to time t5, the output unit 50 stops outputting the integrated value and is placed in a power-saving state. Each of the first to fourth output periods has a length corresponding to a subframe period.

In the first count period from time t5 to time t6, the counter 22 counts the pulse signal for generating the first subframe of the (K+1)th frame, which is the frame next to the Kth frame. Since the same processing as that of the Kth frame is performed for the (K+1)th frame, description thereof will be omitted.

(A) of FIG. 4 illustrates an example in which the output unit 50 outputs only the integrated value in the fourth integration period. (B) of FIG. 4 illustrates an example in which the output unit 50 outputs the respective integrated values in the second and fourth integration periods. Since the counter 22, the readout unit 30, and the integration unit 40 operate in the same manner, the description thereof will be omitted.

As illustrated in (B) of FIG. 4, in the second output period from time t3 to time t4, the output unit 50 can output the integrated value of each pixel in the second integration period to the outside of the imaging device 100. The integrated value of the second integration period is a value obtained by integrating the count values of the first and second subframes. That is, the integrated value of the second integration period does not integrate the count values of the third and fourth subframes. In the first output period from time t2 to time t3 and the third output period from time t4 to time t5, the output unit 50 stops and is placed in the power-saving state.

In the fourth output period from time t5 to time t6, the output unit 50 outputs the integrated value of each pixel in the fourth integration period to the outside of the imaging device 100. The integrated value of the fourth integration period is a value obtained by integrating the count values of the first to fourth subframes. As described above, the output unit 50 may output the integrated value of each of the second integration period and the fourth integration period.

The integrated value of the second integration period is a smaller number of count values than the integrated value of the fourth integration period. That is, since the count values of the M subframe periods smaller than the N subframe periods are integrated as the integrated value of the second integration period, the blur of the object can be reduced, which is suitable for the recognition processing of the object. Since the integrated value in the fourth integration period is a larger number of count values than the integrated value in the second integration period, the luminance can be increased, which is suitable for image display. Each integrated value may be selectively used according to the purpose.

In (C) of FIG. 4, an example in which the output unit 50 outputs the integrated value of each of the first, second, and fourth integration periods will be described. Since the counter 22, the readout unit 30, and the integration unit 40 operate in the same manner, the description thereof will be omitted.

As illustrated in (C) of FIG. 4, in the first output period from time t2 to time t3, the output unit 50 outputs the integrated value of each pixel in the first integration period to the outside of the imaging device 100. The integrated value of the first integration period is the same value as the count value of the first subframe.

In the second output period from time t3 to time t4, the output unit 50 outputs the integrated value of each pixel in the second integration period to the outside of the imaging device 100. The integrated value of the second integration period is a value obtained by integrating the count values of the first and second subframes. In the third output period from time t4 to time t5, the output unit 50 stops and is placed in the power-saving state.

In the fourth output period from time t5 to time t6, the output unit 50 outputs the integrated value of each pixel in the fourth integration period to the outside of the imaging device 100. The integrated value of the fourth integration period is a value obtained by integrating the count values of the first to fourth subframes. As described above, the output unit 50 may output the integrated value of each of the first, second, and fourth integration periods.

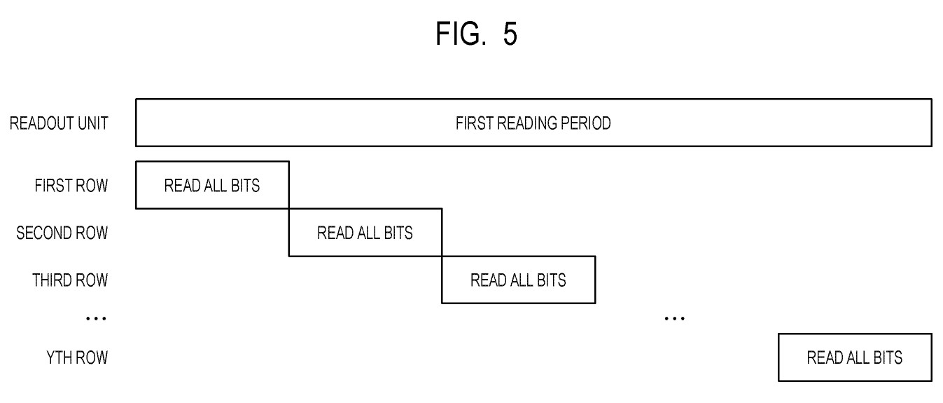

FIG. 5 is a diagram illustrating an operation of the readout unit 30 according to the present embodiment. In the first readout period, the readout unit 30 reads out all bits (here, four bits) of the count value of the memory 23 in units of rows. Similarly, in the second to fourth readout periods, the readout unit 30 reads all bits of the count value of the memory 23 in units of rows. The integration unit 40 integrates all bits of the count value.

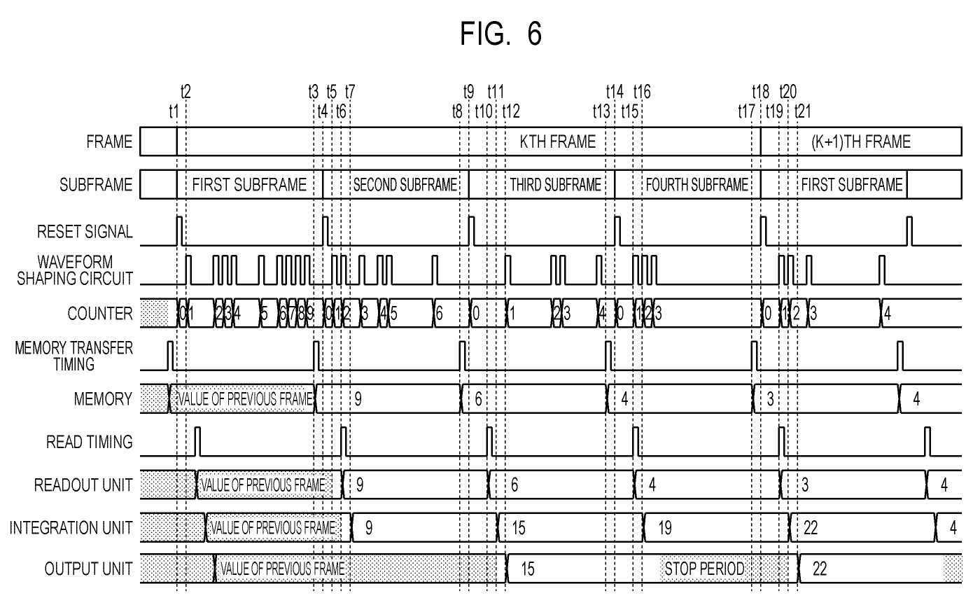

FIG. 6 is a timing chart of the imaging device 100 according to the present embodiment. The operation of the imaging device 100 illustrated in (B) of FIG. 4 will be described in detail with reference to FIG. 6. That is, an operation in which the output unit 50 outputs the respective integrated values in the second and fourth integration periods will be described. In FIG. 6, the operation of one pixel is described for easy understanding of the description.

At time t1, the counter 22 resets the count value and starts counting the pulse signal in the first subframe.

At time t2, the counter 22 receives the pulse signal from the waveform shaping circuit 21 and counts up the count value. Thereafter, the counter 22 counts up the count value every time the pulse signal is input.

At time t3, the memory 23 receives a memory transfer signal from the vertical scanning circuit and holds the count value of the first subframe. Since the count value at time t3 is "9", the memory 23 holds "9". The memory 23 holds the count value of the previous frame before the time t3.

At time t4, the counter 22 resets the count value and starts counting the pulse signal in the second subframe.

At time t5, the counter 22 receives the pulse signal from the waveform shaping circuit 21 and counts up the count value. The count value is incremented to "1".

At time t6, the readout unit 30 receives a readout signal from the control unit 60 and reads out the count value of the memory 23. Since the count value of the memory 23 at time t6 is "9", the readout unit 30 reads the count value "9".

At time t7, the readout unit 30 outputs the count value "9" of the memory 23 to the integration unit 40. The integration unit 40 stores the count value "9" in the integration memory. The integration unit 40 holds the integrated value of the previous frame. After clearing the integrated value in the previous frame period (first frame period), the integration unit 40 stores the count value "9" in the Kth frame period (second frame period) in the integration memory. When a long-time count result exceeding the frame period is desired to be obtained, the integration unit 40 may integrate the count value "9" with the integrated value of the previous frame period without clearing the integrated value of the previous frame period.

At time t8, the memory 23 receives a memory transfer signal from the vertical scanning circuit and holds the count value of the second subframe. Since the count value at time t8 is "6", the memory 23 holds "6".

At time t9, the counter 22 resets the count value and starts counting the pulse signal in the third subframe.

At time t10, the readout unit 30 receives a readout signal from the control unit 60 and reads out the count value of the memory 23. Since the count value of the memory 23 at time t10 is "6", the readout unit 30 reads the count value "6".

At time t11, the readout unit 30 outputs the count value "6" of the memory 23 to the integration unit 40. The integration unit 40 integrates the count value "6" with the count value "9" of the integration memory and stores the integrated value "15" in the integration memory.

At time t12 (start time of the second output period), the output unit 50 outputs the integrated value "15" of the count values of the first and second subframes as a pixel value to the outside of the imaging device 100.

The processes during the periods from t13 to t16 and from t17 to t20 are the same as the processes during the period from t8 to t11, and thus a description thereof is omitted.

At time t21 (start time of the fourth output period), the output unit 50 outputs the integrated value "22" of the count values of the first to fourth subframes in the Kth frame as a pixel value to the outside of the imaging device 100.

As described above, the imaging device 100 according to the present embodiment can output the pixel value obtained by integrating the count values up to the middle of the frame period. That is, the imaging device 100 can output pixel values of count periods having different lengths. The pixel value in the short count period is suitable for the recognition processing of the object because the blur of the object can be reduced. A pixel value in a long count period is suitable for image display because luminance can be increased. The imaging device 100 can output a plurality of pixel values that can be selectively used according to the purpose from the count value of the frame period.

### Second Embodiment

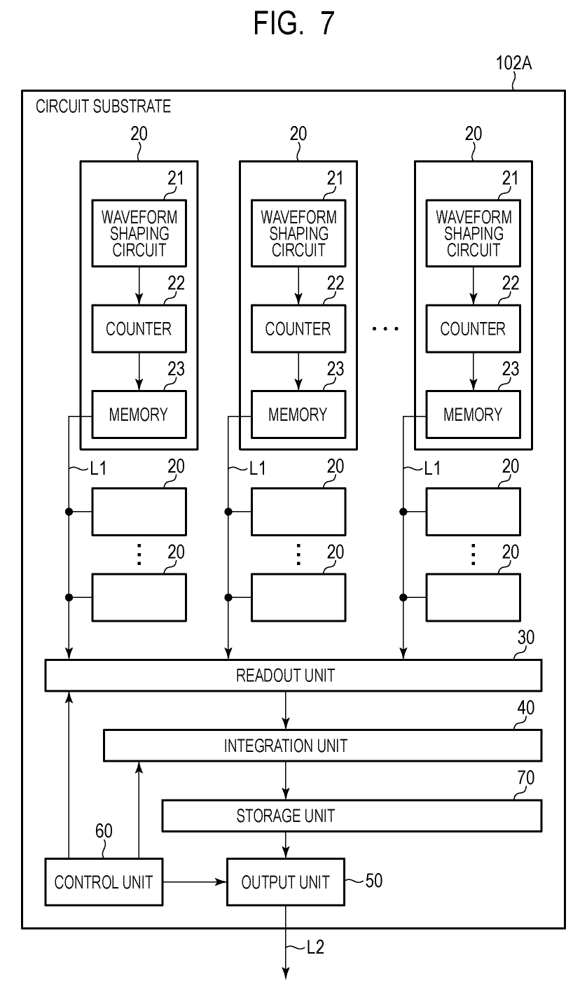

FIG. 7 is a block diagram of a circuit substrate 102A according to the present embodiment. The circuit substrate 102A differs from the circuit substrate 102 according to the first embodiment in that it includes a storage unit 70 for adjusting the timing of outputting pixel values from the output unit 50. The same components as those of the circuit substrate 102 according to the first embodiment are denoted by the same reference numerals, and detailed description thereof will be omitted.

The integration unit 40 outputs the integrated value of the count values to the storage unit 70. The storage unit 70 is a frame memory capable of storing integrated values of all pixels and stores integrated values from the integration unit 40. The output unit 50 outputs the integrated values of the storage unit 70 to the outside of the imaging device 100.

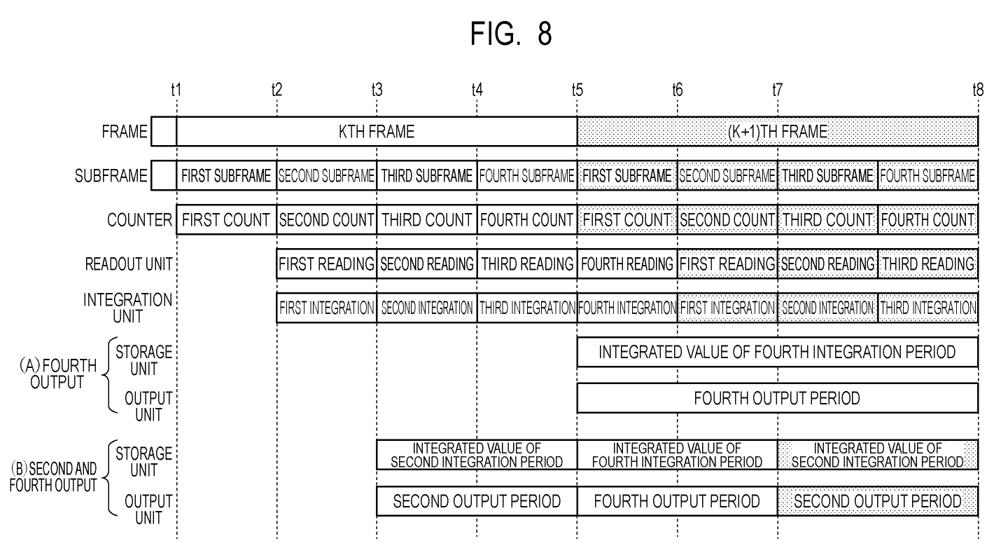

FIG. 8 is a schematic diagram of operation timing of the imaging device 100 according to the present embodiment. Since the operations of the counter 22, the readout unit 30, and the integration unit 40 during the period from t1 to t5 in FIG. 8 are the same as the operations during the period from t1 to t5 in FIG. 4, a description thereof will be omitted.

In the fourth integration period from time t5 to time t6, the integration unit 40 integrates the count value of the fourth readout period with the count value of the integration memory for each pixel and stores the integrated value in the integration memory. The integrated value is a value obtained by integrating the count values of the first to fourth subframes. The integration unit 40 outputs the integrated value of the fourth integration period to the storage unit 70.

In the period from time t5 to time t8, as illustrated in (A) of FIG. 8, the storage unit 70 stores the integrated value of the fourth integration period. The period from time t5 to time t8 has a length corresponding to four subframe periods.

In the fourth output period from time t5 to time t8, the output unit 50 outputs the integrated value of each pixel in the fourth integration period of the storage unit 70 to the outside of the imaging device 100 as a pixel value. The fourth output period is longer than the subframe period and has a length corresponding to four subframe periods.

(A) of FIG. 8 illustrates an example in which the output unit 50 outputs only the integrated value in the fourth integration period. (B) of FIG. 8 illustrates an example in which the output unit 50 outputs the respective integrated values in the second and fourth integration periods.

In the second integration period from time t3 to time t4, the integration unit 40 integrates the count value of the second readout period with the count value of the integration memory for each pixel and stores the integrated value in the integration memory. The integrated value is a value obtained by integrating the count values of the first and second subframes. The integration unit 40 outputs the integrated value of the second integration period to the storage unit 70.

In the period from time t3 to time t5, as illustrated in (B) of FIG. 8, the storage unit 70 stores the integrated value of the second integration period. The period from time t3 to time t5 has a length corresponding to two subframe periods.

In the second output period from time t3 to time t5, the output unit 50 outputs the integrated value of each pixel in the second integration period of the storage unit 70 to the outside of the imaging device 100 as a pixel value. The second output period is longer than the subframe period and has a length corresponding to two subframe periods.

In the fourth integration period from time t5 to time t6, the integration unit 40 integrates the count value of the fourth readout period with the count value of the integration memory for each pixel and stores the integrated value in the integration memory. The integrated value is a value obtained by integrating the count values of the first to fourth subframes. The integration unit 40 outputs the integrated value of the fourth integration period to the storage unit 70.

In the period from time t5 to time t7, as illustrated in (B) of FIG. 8, the storage unit 70 stores the integrated value of the fourth integration period. The period from time t5 to time t7 has a length corresponding to two subframe periods.

In the fourth output period from time t5 to time t7, the output unit 50 outputs the integrated value of each pixel in the fourth integration period of the storage unit 70 to the outside of the imaging device 100 as a pixel value. The fourth output period is longer than the subframe period and has a length corresponding to two subframe periods.

As described above, according to the imaging device 100 according to the present embodiment, the output unit 50 can output the pixel value in the output period longer than the subframe period. Thus, the imaging device 100 can flexibly adjust the output timing of the pixel values.

### Third Embodiment

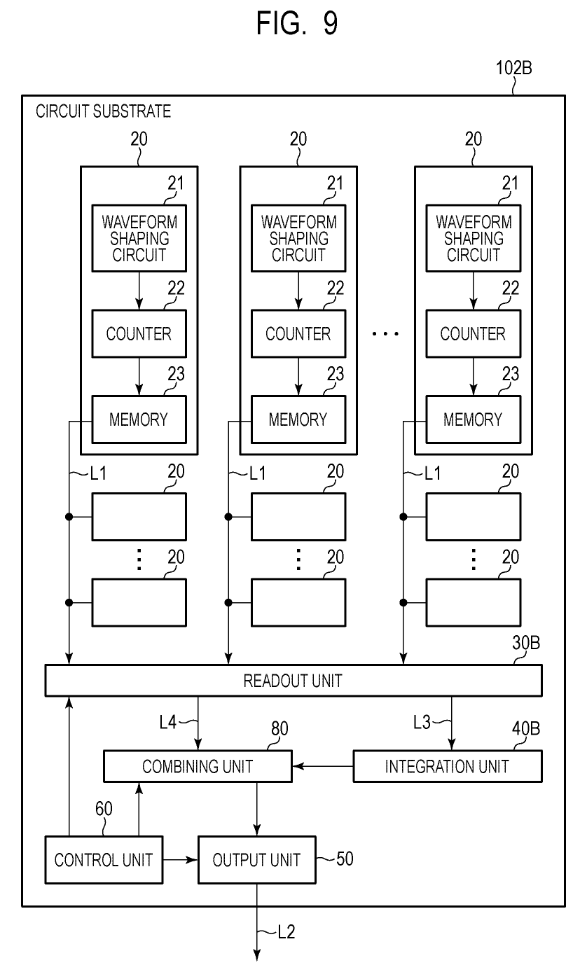

FIG. 9 is a block diagram of a circuit substrate 102B according to the present embodiment. The circuit substrate 102B is different from the circuit substrate 102 according to the first embodiment in that high-order bits of the count value are integrated and combined with low-order bits. The same components as those of the circuit substrate 102 according to the first embodiment are denoted by the same reference numerals, and detailed description thereof will be omitted.

The counter 22 counts the pulse signal and outputs the count value to the memory 23. Further, the counter 22 receives a first reset signal for resetting all bits of the counter 22 from the vertical scanning circuit and resets all bits. Further, the counter 22 receives a second reset signal for resetting only the most significant bit (MSB) and resets the most significant bit.

The readout unit 30B reads all bits of the count value from the memory 23 of the plurality of pixels in units of rows, and outputs the most significant bit of the count value to the integration unit 40B via the signal line L3. The readout unit 30B outputs the low-order bits of the count value to the combining unit 80 via the signal line L4. The low-order bits of the count value are bits excluding the most significant bit of all bits of the count value. When the count value is 4 bits, the low-order bits are 3 bits.

The integration unit 40B integrates the most significant bit of the count value from the readout unit 30B for each pixel. The integration unit 40B includes an integration memory that holds the integrated value of the most significant bit of the count value. The integration unit 40B integrates the most significant bit of the count value from the readout unit 30B with the most significant bit of the count value read out from the integration memory for each pixel and writes the integrated value of the most significant bit into the integration memory. The integration unit 40B outputs the integrated value of the integrating memory to the combining unit 80.

The combining unit 80 receives the control signal from the control unit 60, combines the integrated value of the most significant bit from the integration unit 40B and the low-order bits of the count value from the readout unit 30B to generate a pixel value, and outputs the pixel value to the output unit 50.

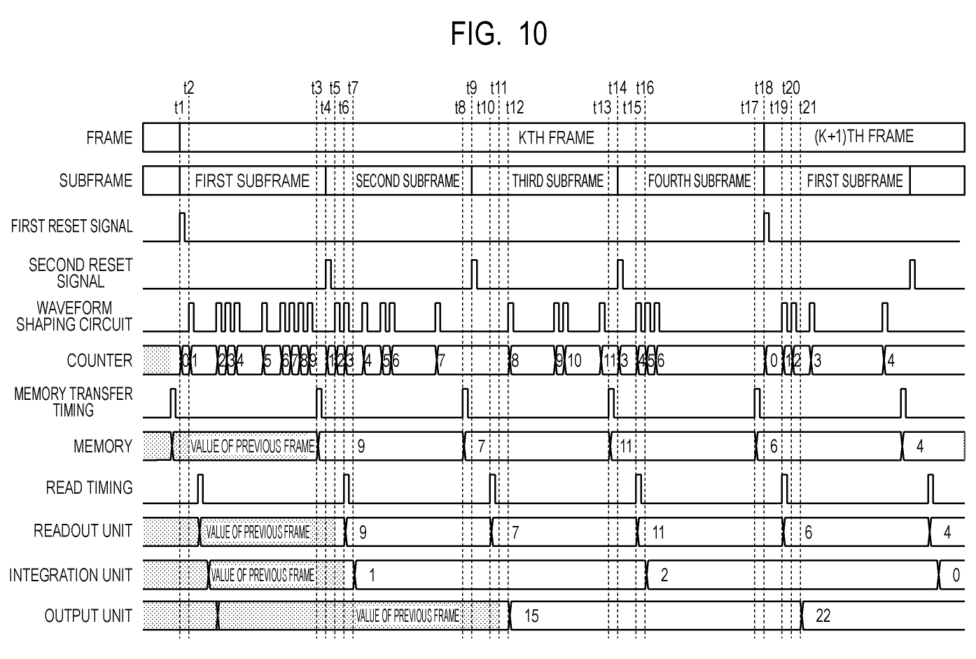

FIG. 10 is a timing chart of the imaging device 100 according to the present embodiment. In FIG. 10, an operation in which the output unit 50 outputs the respective integrated values in the second and fourth integration periods will be described. In FIG. 10, the operation of one pixel is described for easy understanding of the description.

At time t1, the counter 22 receives a first reset signal from the vertical scanning circuit, resets all bits of the count value, and starts counting the pulse signal in a first subframe.

At time t2, the counter 22 receives the pulse signal from the waveform shaping circuit 21 and counts up a count value. Thereafter, the counter 22 counts up the count value every time the pulse signal is input.

At time t3, the memory 23 receives a memory transfer signal from the vertical scanning circuit and holds the count value of the first subframe. Since the count value at time t3 is "9", the memory 23 holds "9". The memory 23 holds the count value of the previous frame before the time t3.

At time t4, the counter 22 receives a second reset signal from the vertical scanning circuit and resets the most significant bit of the count value. Since the count value is "1001" in binary ("9" in decimal), when the most significant bit of the count value is reset, the count value becomes "0001" in binary ("1" in decimal).

At time t5, the counter 22 receives the pulse signal from the waveform shaping circuit 21 and counts up the count value. The count value is incremented to "2" in decimal.

At time t6, the readout unit 30 receives a readout signal from the control unit 60 and reads out the count value of the memory 23. Since the count value of the memory 23 at time t6 is "9", the readout unit 30 reads the count value "9".

At time t7, the readout unit 30 outputs the most significant bit "1" of the count value "1001" in binary ("9" in decimal) of the memory 23 to the integration unit 40B. The integration unit 40B stores the most significant bit "1" in the integration memory. The integration unit 40B holds the integrated value of the most significant bit of the previous frame. After clearing the integrated value of the most significant bit of the previous frame, the integration unit 40B stores the most significant bit "1" in the integration memory. When it is desired to obtain a long-time count result exceeding the frame period, the integration unit 40B may integrate the most significant bit "1" into the integrated value of the most significant bit of the previous frame without clearing the integrated value of the most significant bit of the previous frame.

At time t8, the memory 23 receives a memory transfer signal from the vertical scanning circuit and holds the count value of the second subframe. Since the count value at time t8 is "7", the memory 23 holds "7".

At time t9, the counter 22 receives a second reset signal from the vertical scanning circuit and resets the most significant bit of the count value. Since the count value is "0111" in binary ("7" in decimal), even if the most significant bit of the count value is reset, the count value does not change and is "0111" in binary ("7" in decimal).

At time t10, the readout unit 30 receives a readout signal from the control unit 60 and reads out the count value of the memory 23. Since the count value of the memory 23 at time t10 is "7", the readout unit 30 reads the count value "7".

At time t11, the readout unit 30 outputs the most significant bit "0" of the count value "0111" in binary ("7" in decimal) of the memory 23 to the integration unit 40B. The integration unit 40B integrates the most significant bit "0" with the most significant bit "1" in the integration memory and stores the integrated value "1" in the integration memory. The integration unit 40B outputs the integrated value "1" to the combining unit 80. The integrated value "1" indicates the number of the most significant bit "1". That is, the integrated value "1" indicates that the number of the most significant bit "1" of the count value is one. Since the count value is 4 bits, the integrated value "1" of the most significant bit is "1000" in binary ("8" in decimal). The integrated value "1" is an example of the fourth integrated value.

At time t12, the combining unit 80 combines the integrated value "1" ("1000" in binary) of the most significant bit from the integration unit 40B and the low-order bits "111" ("7" in decimal) from the readout unit 30 to generate the integrated value ("1111" in binary, "15" in decimal) of all bits. The combining unit 80 outputs the integrated value of all bits to the output unit 50. The integrated value is a value obtained by integrating the count values of the first and second subframes. In the second output period, the output unit 50 outputs the integrated value ("15" in decimal) as a pixel value to the outside of the imaging device 100.

The processes during the periods from t13 to t16 and from t17 to t20 are the same as the processes during the period from t8 to t11, and thus a description thereof is omitted.

At time t21, the combining unit 80 combines the integrated value "2" ("10000" in binary) of the most significant bit from the integration unit 40B and the low-order bits "110" ("6" in decimal) from the readout unit 30. Since the number of the most significant bit "1" in the four bits is two, the integrated value "2" of the most significant bit is "10000" in binary ("16" in decimal). The combining unit 80 generates the integrated value of all bits ("10110" in binary, "22" in decimal) and outputs the integrated value to the output unit 50. The integrated value is a value obtained by integrating the count values of the first to fourth subframes. In the fourth output period, the output unit 50 outputs the integrated value ("22" in decimal) as a pixel value to the outside of the imaging device 100. The integrated value "2" of the most significant bit is an example of the third integrated value.

As described above, according to the imaging device 100 according to the present embodiment, since the most significant bit of the count value is integrated and combined with the low-order bits, the processing speed can be improved as compared with the imaging device 100 according to the first embodiment in which all bits of the count value are integrated.

### Fourth Embodiment

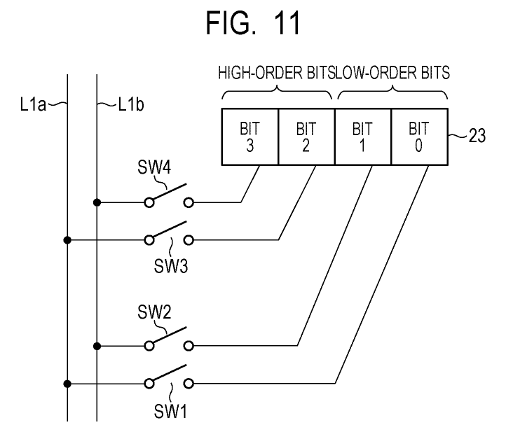

FIG. 11 is a circuit diagram of a memory 23 and signal lines L1a and L1b according to the present embodiment. The imaging device 100 according to the present embodiment is different from the imaging device 100 according to the third embodiment in which all bits of the count value are read from the memory 23 in that the high-order bits and the low-order bits of the count value are separately read from the memory 23.

The memory 23 is a 4-bit latch circuit (storage element) and is provided in the circuit region 102a. The signal lines L1a and L1b are interconnected in each column of the circuit region 102a. The latch circuit of bit 0 in the memory 23 is connected to the signal line L1a via the switch SW1, and the latch circuit of bit 1 is connected to the signal line L1b via the switch SW2. The latch circuit of bit 2 is connected to the signal line L1a via the switch SW3, and the latch circuit of bit 3 is connected to the signal line L1b via the switch SW4. Bit 0 and bit 1 are low-order bits, and bit 2 and bit 3 are high-order bits.

When the vertical scanning circuit switches on or off the switches SW1 to SW4, one of the latch circuits of the high-order bits or the latch circuits of the low-order bits is electrically connected to the readout unit 30 via the signal lines L1a and L1b. When the vertical scanning circuit turns on the switches SW3 and SW4 and turns off the switches SW1 and SW2, the latch circuits of the high-order bits are connected to the readout unit 30 via the signal lines L1a and L1b. When the vertical scanning circuit turns on the switches SW1 and SW2 and turns off the switches SW3 and SW4, the latch circuits of the low-order bits are connected to the readout unit 30 via the signal lines L1a and L1b. When the vertical scanning circuit switches the switches, the two signal lines L1a and L1b can output four bits. The number of signal lines can be reduced as compared to the case where four signal lines output four bits. A reduction in the number of signal lines is effective in the case where the area of the signal lines interconnected in the circuit region 102a is limited by miniaturization of pixels.

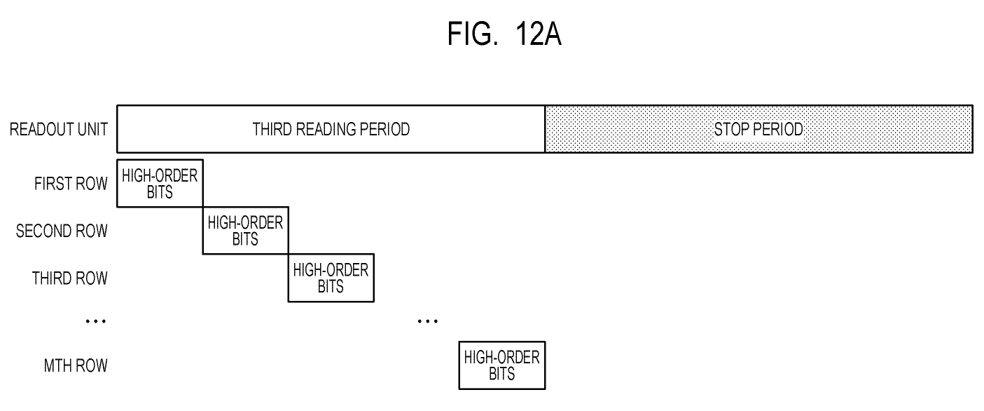

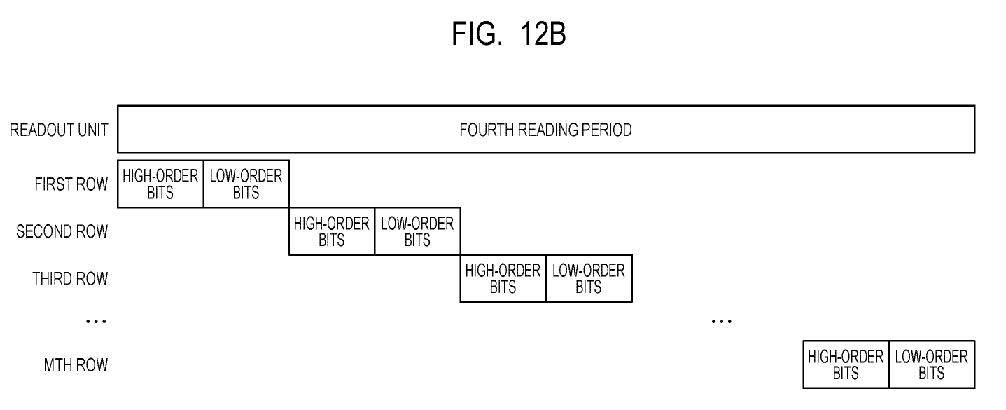

FIGS. 12A and 12B are diagrams illustrating an operation of the readout unit 30B according to the present embodiment. As illustrated in FIG. 12A, in the third readout period, the readout unit 30B reads out only the high-order bits of the count value of the memory 23 in units of rows. Specifically, in a state where the latch circuits of the high-order bits of the memory 23 are connected to the readout unit 30B via the signal lines L1a and L1b, the readout unit 30B reads out the high-order bits of the count value of the memory 23 in the pixels of the first row of the circuit region 102a. Similarly, the readout unit 30B reads out the high-order bits of the count value in the pixels in the second row of the circuit region 102a. The readout unit 30B similarly reads out the high-order bits of the count value also in the pixels of the third row to the Mth row of the circuit region 102a. In the third reading period, the readout unit 30B can read only the high-order bits of the count value in a time shorter than the time for reading the high-order bits and the low-order bits of the count value. The third reading period is about half of the fourth reading period in which all bits of the count value of the memory 23 are read. The readout unit 30B is placed in a power-saving state after completing the readout of only the high-order bits of the count value until the start of the next readout period.

As illustrated in FIG. 12B, in the fourth readout period, the readout unit 30B reads out the high-order bits and the low-order bits of the count value of the memory 23 in units of rows. Specifically, in the pixels of the first row of the circuit region 102a, in a state where the latch circuits of the high-order bits of the memory 23 are connected to the readout unit 30B via the signal lines L1a and L1b, the readout unit 30B reads out the high-order bits of the count value of the memory 23. In a state where the latch circuits of the low-order bits of the memory 23 are connected to the readout unit 30B via the signal lines L1a and L1b, the readout unit 30B reads out the low-order bits of the count value of the memory 23. Similarly, the readout unit 30B reads out the high-order bits and the low-order bits of the count value of the memory 23 also in the pixels in the second row to the Mth row of the circuit region 102a. Since the readout unit 30B reads the high-order bits and the low-order bits, the reading operation is not stopped in the fourth reading period.

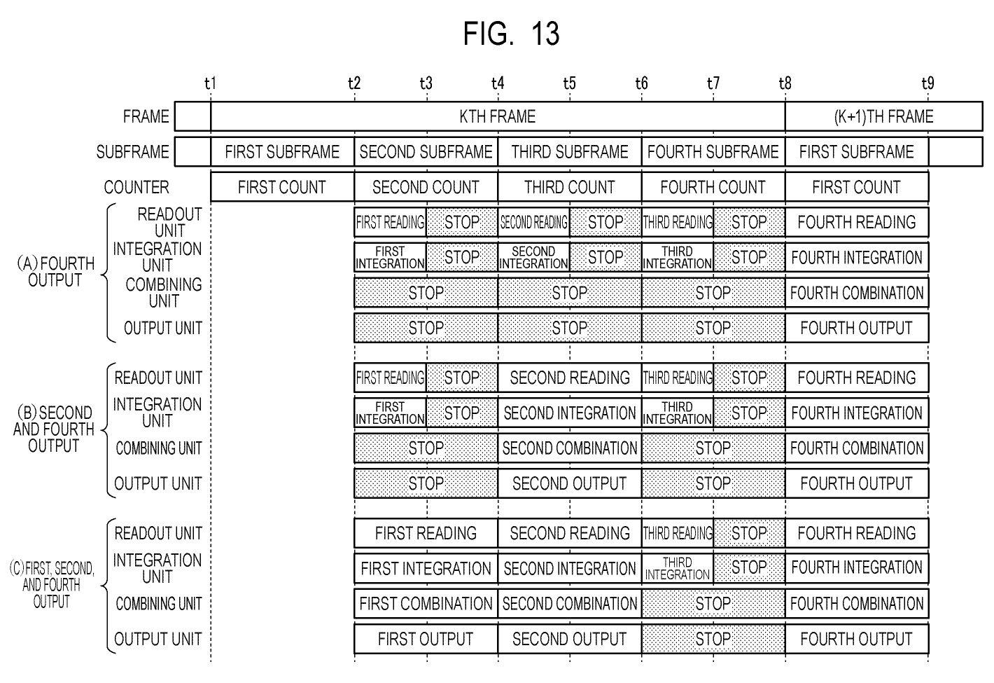

FIG. 13 is a schematic diagram of operation timing of the imaging device 100 according to the present embodiment. In the first count period from time t1 to time t2, the counter 22 counts the pulse signal for generating the first subframe. The memory 23 holds the count value from the counter 22. After the first count period ends, the counter 22 resets the high-order bits.

In the first readout period from time t2 to time t3, the readout unit 30B reads out the high-order bits of the count value of the first subframe from the memory 23 of the plurality of pixels in units of rows. The readout unit 30B outputs the high-order bits of the count value to the integration unit 40B.

In the first integration period from time t2 to time t3, the integration unit 40B stores the high-order bits of the count value in the first readout period in the integration memory.

In the second count period from time t2 to time t4, the counter 22 counts the pulse signal for generating the second subframe. The memory 23 holds the count value from the counter 22. After the second count period ends, the counter 22 resets the high-order bits.

In the idle period from time t3 to time t4, the readout unit 30B stops because it does not read out the low-order bits of the count value of the first subframe and is placed in the power-saving state.

In the idle period from the time t3 to the time t4, the integration unit 40B does not integrate the low-order bits of the count value of the first subframe and thus stops and is placed in the power-saving state.

In the second readout period from time t4 to time t5, the readout unit 30B reads out the high-order bits of the count value of the second subframe from the memory 23 of the plurality of pixels in units of rows. The readout unit 30B outputs the high-order bits of the count value to the integration unit 40B.

In the second integration period from time t4 to time t5, the integration unit 40B integrates the high-order bits of the count value in the second readout period into the high-order bits of the integration memory for each pixel and stores the integrated value in the integration memory. The integrated value is a value obtained by integrating high-order bits of the count values of the first and second subframes.

In the third count period from time t4 to time t6, the counter 22 counts the pulse signal for generating the third subframe. The memory 23 holds the count value from the counter 22. After the third count period ends, the counter 22 resets the high-order bits.

In the idle period from time t5 to time t6, the readout unit 30B stops because it does not read out the low-order bits of the count value of the second subframe and is placed in the power-saving state.

In the idle period from the time t5 to the time t6, the integration unit 40B does not integrate the low-order bits of the count value of the second subframe and thus stops and is placed in the power-saving state.

In the third readout period from time t6 to time t7, the readout unit 30B reads out the high-order bits of the count value of the third subframe from the memory 23 of the plurality of pixels in units of rows. The readout unit 30B outputs the high-order bits of the count value to the integration unit 40B.

In the third integration period from time t6 to time t7, the integration unit 40B integrates the high-order bits of the count value in the third readout period into the high-order bits of the integration memory for each pixel and stores the integrated value in the integration memory. The integrated value is a value obtained by integrating the high-order bits of the count values of the first to third subframes.

In the fourth count period from time t6 to time t8, the counter 22 counts the pulse signal for generating the fourth subframe. The memory 23 holds the count value from the counter 22. After the fourth count period ends, the counter 22 resets all bits.

In the idle period from time t7 to time t8, the readout unit 30B stops because it does not read out the low-order bits of the count value of the third subframe and is placed in the power-saving state.

In the idle period from the time t7 to the time t8, the integration unit 40B does not integrate the low-order bits of the count value of the third subframe and thus stops and is placed in the power-saving state.

In the fourth readout period from time t8 to time t9, the readout unit 30B reads out the high-order bits and the low-order bits of the count value of the fourth subframe from the memory 23 of the plurality of pixels in units of rows. The readout unit 30B outputs the high-order bits to the integration unit 40B and outputs the low-order bits to the combining unit 80.

In the fourth integration period from time t8 to time t9, the integration unit 40B integrates the high-order bits of the count value in the fourth readout period into the high-order bits of the integration memory for each pixel and stores the integrated value in the integration memory. The integrated value is a value obtained by integrating the high-order bits of the count values of the first to fourth subframes. That is, the integrated value is a value obtained by integrating the high-order bits of the count values of the N subframe periods. The integration unit 40B outputs the integrated value of the high-order bits to the combining unit 80.

In the fourth combination period from time t8 to time t9, as illustrated in (A) of FIG. 13, the combining unit 80 combines the integrated value of the high-order bits of the fourth integration period and the low-order bits of the count value from the readout unit 30B for each pixel to generate a pixel value, and outputs the pixel value to the output unit 50.

In the fourth output period from time t8 to time t9, the output unit 50 outputs the pixel value of the fourth integration period from the combining unit 80 to the outside of the imaging device 100. In addition, in the period from the time t2 to the time t8, the output unit 50 stops and is placed in the power-saving state. The output unit 50 illustrated in (A) of FIG. 13 outputs only the integrated value of the fourth integration period among the first integration period to the fourth integration period.

(A) of FIG. 13 illustrates an example in which the output unit 50 outputs only the integrated value in the fourth integration period. (B) of FIG. 13 illustrates an example in which the output unit 50 outputs the respective integrated values in the second and fourth integration periods. Since the counter 22 operates in the same manner, the description thereof will be omitted. Since the operation from time t1 to time t4 is the same as the operation in (A) of FIG. 13, the description thereof is omitted.

In the second readout period from time t4 to time t6, the readout unit 30B reads out the high-order bits and the low-order bits of the count value of the second subframe from the memory 23 of the plurality of pixels in units of rows. The readout unit 30B outputs the high-order bits to the integration unit 40B and outputs the low-order bits to the combining unit 80.

In the second integration period from time t4 to time t6, the integration unit 40B integrates the high-order bits of the count value in the second readout period into the high-order bits of the integration memory for each pixel and stores the integrated value in the integration memory. The integrated value is a value obtained by integrating the high-order bits of the count values of the first and second subframes. That is, the integrated value is a value obtained by integrating the high-order bits of the count values of M subframe periods smaller than N subframe periods. The integration unit 40B outputs the integrated value of the high-order bits to the combining unit 80.

In the second combination period from the time t4 to the time t6, the combining unit 80 combines the integrated value of the high-order bits of the second integration period and the low-order bits of the count value from the readout unit 30B for each pixel to generate the pixel value of the second integration period, and outputs the pixel value to the output unit 50.

In the second output period from time t4 to time t6, the output unit 50 outputs the pixel value of the second integration period from the combining unit 80 to the outside of the imaging device 100. Since the operation from time t6 to time t8 is the same as the operation of (A) of FIG. 13, the description thereof will be omitted.

In the fourth output period from time t8 to time t9, the output unit 50 outputs the pixel value of the fourth integration period from the combining unit 80 to the outside of the imaging device 100. As described above, the output unit 50 may output the pixel values of the second integration period and the fourth integration period.

In (C) of FIG. 13, an example in which the output unit 50 outputs the integrated values of the first, second, and fourth integration periods will be described.

Since the operation from time t1 to time t2 is the same as the above-described operation, the description thereof will be omitted. In the first readout period from time t2 to time t4, the readout unit 30B reads out the high-order bits and the low-order bits of the count value of the first subframe from the memory 23 of the plurality of pixels in units of rows. The readout unit 30B outputs the high-order bits to the integration unit 40B and outputs the low-order bits to the combining unit 80.

In the first integration period from time t2 to time t4, the integration unit 40B stores the high-order bits of the count value in the first readout period in the integration memory for each pixel. The integration unit 40B outputs the high-order bits of the count value to the combining unit 80.

In the first combination period from time t2 to time t4, the combining unit 80 combines the high-order bits of the integrated value (count value) in the first integration period and the low-order bits of the count value from the readout unit 30B for each pixel to generate a pixel value in the first integration period, and outputs the pixel value to the output unit 50.

In the first output period from time t2 to time t4, the output unit 50 outputs the pixel value of the first integration period from the combining unit 80 to the outside of the imaging device 100.

In the second output period from time t4 to time t6, the output unit 50 outputs the pixel value of the second integration period from the combining unit 80 to the outside of the imaging device 100. Since the operation from time t6 to time t8 is the same as the operation of (A) of FIG. 13, the description thereof will be omitted.

In the fourth output period from time t8 to time t9, the output unit 50 outputs the pixel value of the fourth integration period from the combining unit 80 to the outside of the imaging device 100. As described above, the output unit 50 may output the integrated values of the first, second, and fourth integration periods.

As described above, according to the imaging device 100 according to the present embodiment, since the readout unit 30B does not read the low-order bits of the count value of the memory 23 in the predetermined reading period, it is possible to stop the reading in a part of the reading period and to save power. In addition, the integration unit 40B can be stopped in accordance with the idle period of the readout unit 30B, and power saving can be achieved.

### Fifth Embodiment

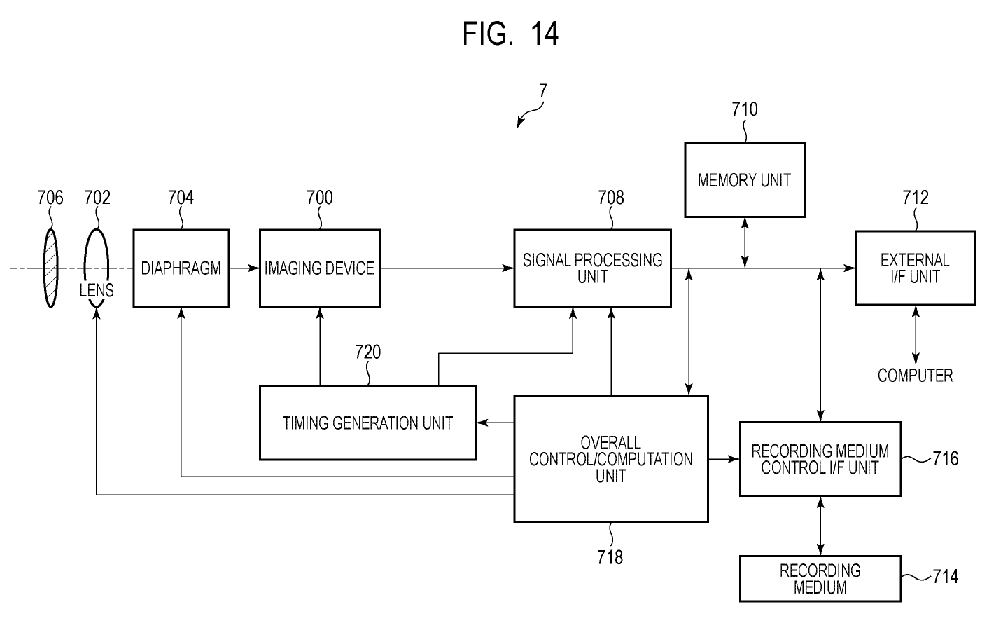

The imaging device in the above-described embodiments can be applied to various devices. Examples of the device include a digital still camera, a digital camcorder, a camera head, a copier, a fax machine, a mobile phone, an in-vehicle camera, an observation satellite, and a monitoring camera. FIG. 14 is a block diagram of a digital still camera.

The device 7 includes an imaging device 700, a lens 702, a diaphragm 704, and a barrier 706. The device 7 further includes a signal processing unit (processing device) 708, a memory unit (storage device) 710, an external I/F unit 712, a recording medium 714, a recording medium control I/F unit 716, an overall control/computation unit (control device) 718, and a timing generation unit 720. At least one of the barrier 706, the lens 702, and the diaphragm 704 is an optical device corresponding to the device. The barrier 706 protects the lens 702, and the lens 702 forms an optical image of an object on the imaging device 700. The diaphragm 704 makes the amount of light passing through the lens 702 variable. The imaging device 700 is configured as in the above-described embodiment, and converts an optical image formed by the lens 702 into image data (image signal). The signal processing unit 708 performs various corrections, data compression, and the like on the imaging data output from the imaging device 700. The timing generation unit 720 outputs various timing signals to the imaging device 700 and the signal processing unit 708. The overall control/arithmetic unit 718 controls the entire digital still camera, and the memory unit 710 temporarily stores image data. The recording medium control I/F unit 716 is an interface for recording or reading image data on or from the recording medium 714, and the recording medium 714 is a detachable recording medium such as a semiconductor memory for recording or reading imaging data. The external I/F unit 712 is an interface for communicating with an external computer or the like. The timing signal and the like may be input from the outside of the device. The device 7 may further include a display device (a monitor, an electronic viewfinder, or the like) that displays information obtained by the imaging device 700. The device 7 includes at least one of an optical device, a control device, a processing device, a display device, a storage device, and a mechanical device that operates based on information obtained by the imaging device 700. The mechanical device is a movable unit (for example, a robot arm) that operates by receiving a signal from the imaging device 700.

Each pixel may include a plurality of photoelectric conversion units (a first photoelectric conversion unit and a second photoelectric conversion unit). The signal processing unit 708 may be configured to process the pixel signal based on the charge generated in the first photoelectric conversion unit and the pixel signal based on the charge generated in the second photoelectric conversion unit and acquire distance information from the imaging device 700 to an object.

### Sixth Embodiment

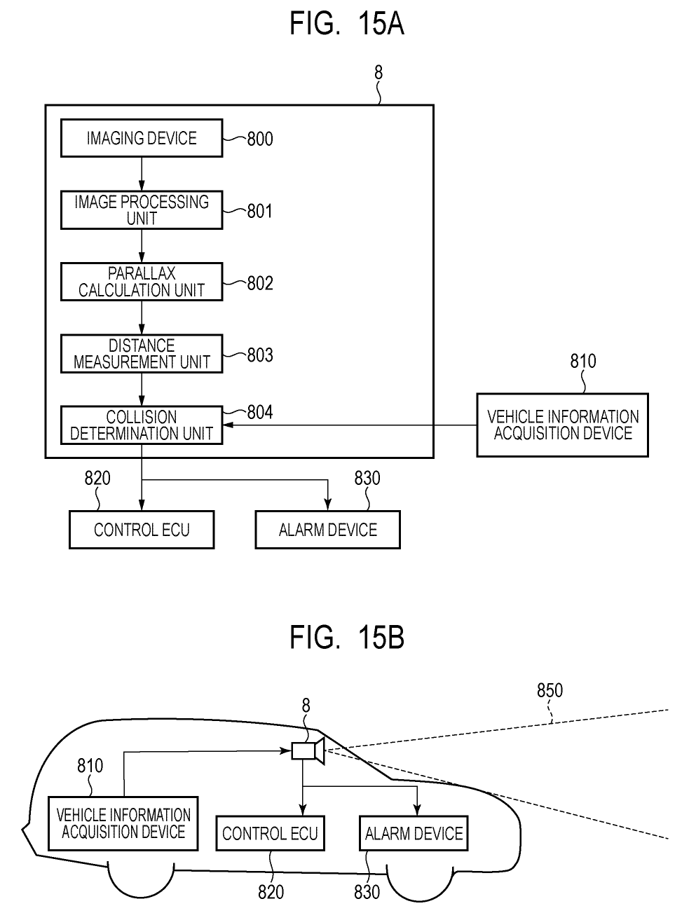

FIGS. 15A and 15B are block diagrams of equipment related to an in-vehicle camera according to the present embodiment. The equipment 8 includes the imaging device 800 of the above-described embodiment and a signal processing device that processes a signal from the imaging device 800. The equipment 8 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 8. In addition, the equipment 8 includes a distance measurement unit 803 that calculates a distance to the object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to an object. That is, the distance information is information related to a parallax, a defocus amount, a distance to an object, and the like. The collision determination unit 804 may determine the collision possibility using any of these pieces of distance information. The distance information acquisition unit may be realized by dedicatedly designed hardware or may be realized by a software module. Also, it may be realized by FPGA (Field Programmable Gate Array), ASIC (Application Specific Integrated Circuit) or a combination thereof.

The equipment 8 is connected to the vehicle information acquisition device 810 and can acquire vehicle information such as a vehicle speed, a yaw rate, and a steering angle. In addition, a control ECU 820, which is a control device that outputs a control signal for generating a braking force to the vehicle based on the determination result of the collision determination unit 804, is connected to the equipment 8. The equipment 8 is also connected to an alarm device 830 that issues an alarm to the driver based on the determination result of the collision determination unit 804. For example, when the determination result of the collision determination unit 804 indicates that the possibility of collision is high, the control ECU 820 performs vehicle control to avoid collision and reduce damage by, for example, applying a brake, returning an accelerator, or suppressing engine output. The alarm device 830 gives a warning to the user by sounding a warning such as a sound, displaying warning information on a screen of a car navigation system or the like, giving vibration to a seat belt or a steering wheel, or the like. The equipment 8 functions as a control unit that controls the operation of controlling the vehicle as described above.

In the present embodiment, the surroundings of the vehicle, for example, the front or the rear is imaged by the equipment 8. FIG. 15B illustrates a device in a case of capturing an image in front of the vehicle (imaging range 850). The vehicle information acquisition device 810 serving as the imaging control means sends an instruction to the equipment 8 or the imaging device 800 to perform the imaging operation. With such a configuration, the accuracy of distance measurement can be further improved.

In the above description, an example in which control is performed so as not to collide with another vehicle has been described, but the present embodiment is also applicable to control in which automatic driving is performed so as to follow another vehicle, control in which automatic driving is performed so as not to protrude from a lane, and the like. Furthermore, the device is not limited to vehicles such as automobiles, and can be applied to, for example, ships, aircrafts, artificial satellites, industrial robots, consumer robots, and the like mobile object (mobile devices). In addition, the present embodiment is not limited to mobile object and can be widely applied to devices utilizing object recognition or biological recognition, such as an intelligent traffic system (ITS) and a monitoring system.

### Modified Embodiments

The present disclosure is not limited to the above embodiment, and various modifications are possible. For example, an example in which a partial configuration of one embodiment is added to another embodiment or an example in which a partial configuration of one embodiment is replaced with a partial configuration of another embodiment is also an embodiment of the present disclosure.

For example, the signal processing circuit 20 may not include the memory 23. In this case, the counter 22 is connected to the readout unit 30 via the signal line L1, and outputs the count value to the readout unit 30.

The arrangement of pixels in the pixel region 101a may be one-dimensionally arranged. The signal processing circuit 20 is not necessarily provided for each pixel, for example, one signal processing circuit 20 may be shared by a plurality of pixels and signal processing may be sequentially performed.

Instead of the counter 22, a time-to-digital conversion circuit (Time to Digital Converter: TDC) and a memory may be used to acquire the pulse detection timing. In this case, the generation timing of the pulse signal output from the waveform shaping circuit 21 is converted into a digital signal by the TDC. In order to measure the timing of the pulse signal, a control pulse (reference signal) is output to the TDC from the vertical scanning circuit unit via the drive line. The TDC acquires, as a digital signal, a signal when the input timing of the signal output via the waveform shaping circuit 21 is set to a relative time with reference to the control pulse.

The number of divisions of the frame period is not limited to "4". As the number of divisions increases, the speed of reading from the pixel increases, but on the other hand, it is possible to obtain an integrated value of a larger number of bits with respect to the number of bits of the counter 22.

The pixel may have a memory that holds a carry bit of the count value. The readout unit 30B reads the carry bit from the memory. The integration unit 40B integrates the carry bits of the N subframe periods to generate a fifth integrated value. The combining unit 80 combines the fifth integrated value and the count value to generate a first integrated value. The integration unit 40B integrates the carry bits of M subframe periods smaller than N subframe periods to generate a sixth integrated value. The combining unit 80 combines the sixth integrated value and the count value to generate a second integrated value.

The counter 22 may change the number of bits of the count value held in the memory 23 to high-order bits or all bits for each reading period.

The integration unit 40 may integrate the count value after performing various arithmetic processing on the count value from the readout unit 30.

According to the present disclosure, it is possible to realize an imaging device capable of outputting a plurality of integrated values from a count value of a frame period.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-003980, filed January 10, 2025, which is hereby incorporated by reference herein in its entirety.

What is claimed is:

1. An imaging device comprising:
a pixel including a light receiving unit configured to receive light and generate a pulse signal, and a counter configured to count the pulse signal;
a readout unit configured to read a count value of the pulse signal in each of N subframe periods, where N is an integer of 2 or more and a frame period includes the N subframe periods;
an integration unit configured to integrate the count values read by the readout unit; and
an output unit configured to output a first integrated value obtained by integrating the count values of the N subframe periods by the integration unit,
wherein the output unit determines, for each of N subframes, whether to output a second integrated value obtained by integrating the count values of M subframe periods using the integration unit, where M is smaller than N.

2. The imaging device according to claim 1, wherein the output unit outputs the first integrated value or the second integrated value in an output period having a length corresponding to the subframe period.

3. The imaging device according to claim 1, further comprising a storage unit configured to store the first integrated value and the second integrated value,
wherein the output unit outputs the first integrated value or the second integrated value stored in the storage unit in an output period longer than the subframe period.

4. The imaging device according to claim 1, wherein the output unit outputs the first integrated value after outputting the second integrated value.

5. The imaging device according to claim 1,
wherein the count value includes a plurality of bits,
wherein the readout unit reads all bits of the count value, and
wherein the integration unit integrates all bits of the count values obtained in the N subframe periods to generate the first integrated value, and integrates all bits of the count values obtained in the M subframe periods smaller than the N subframe periods to generate the second integrated value.

6. The imaging device according to claim 1, further comprising a combining unit configured to combine a plurality of bits,
wherein the count value includes a plurality of bits,
wherein the readout unit reads high-order bits and low-order bits of the count value,
wherein the integration unit integrates the high-order bits of the count values obtained in the N subframe periods to generate a third integrated value,
wherein the combining unit combines the third integrated value and the low-order bits of the count value read by the readout unit to generate the first integrated value,
wherein the integration unit integrates the high-order bits of the count values obtained in the M subframe periods smaller than the N subframe periods to generate a fourth integrated value, and
wherein the combining unit combines the fourth integrated value and the low-order bits of the count value read by the readout unit to generate the second integrated value.

7. The imaging device according to claim 1,
wherein the pixel includes a memory that holds the count value, and
wherein the readout unit reads the count value from the memory.

8. The imaging device according to claim 7, further comprising:
a signal line connected to the readout unit; and
a switch configured to switch a connection between the signal line and the memory,
wherein the memory includes a plurality of memory elements, and
wherein the switch connects either the memory element for the high-order bits or the memory element for the low-order bits of the memory to the signal line.

9. The imaging device according to claim 8, wherein the readout unit reads high-order bits and low-order bits of the count value in a readout period having a length corresponding to the subframe period.

10. The imaging device according to claim 9, wherein the readout unit reads only the high-order bits of the count value in a shorter time than that required for reading the high-order bits and the low-order bits of the count value in the readout period.

11. The imaging device according to claim 10, wherein the readout unit is placed in a power-saving state after completion of readout of only the high-order bits of the count value until a start of the next readout period.

12. The imaging device according to claim 2, wherein the output unit is placed in a power-saving state when the first integrated value and the second integrated value are not output in the output period.

13. The imaging device according to claim 1,
wherein the plurality of frame periods include a first frame period and a second frame period subsequent to the first frame period, and
wherein the integration unit integrates the count value of the second frame period with the first integrated value of the first frame period.

14. The imaging device according to claim 1,
wherein the plurality of frame periods include a first frame period and a second frame period subsequent to the first frame period, and
wherein the integration unit integrates the count value of the second frame period after clearing the first integrated value of the first frame period.

15. The imaging device according to claim 1, further comprising a combining unit configured to combine a plurality of bits,
wherein the pixel includes a memory configured to hold a carry bit of the count value,
wherein the readout unit reads the carry bit from the memory,
wherein the integration unit integrates the carry bits of the N subframe periods to generate a fifth integrated value, and
wherein the combining unit combines the fifth integrated value and the count value read by the readout unit to generate the first integrated value,
wherein the integration unit integrates the carry bits of the M subframe periods smaller than the N subframe periods to generate a sixth integrated value, and
wherein the combining unit combines the sixth integrated value and the count value read by the readout unit to generate the second integrated value.

16. The imaging device according to claim 1,
wherein the readout unit reads the count value in chronological order for the N subframe periods, and
wherein the integration unit integrates the count value in the order in which the readout unit reads the count value.

17. The imaging device according to claim 6,
wherein the pixel includes a memory configured to hold the count value, and
wherein the counter changes the number of bits of the count value to be held in the memory to the high-order bits or all bits for each readout period having a length corresponding to the subframe period.

18. An equipment comprising:
the imaging device according to claim 1; and
at least one of
an optical device corresponding to the imaging device,
a control device configured to control the imaging device,
a processing device configured to process a signal output from the imaging device,
a display device configured to display information obtained by the imaging device,
a storage device configured to store information obtained by the imaging device, and
a mechanical device configured to operate based on information obtained by the imaging device.

19. The equipment according to claim 18, wherein the processing device acquires distance information from the imaging device to an object.
